(19) United States
(12) Patent Application Publication
(10) Pub. No.: US 2007/0168297 A1
(43) Pub. Date: Jul. 19, 2007

(54) Efficient method and system for secure business-to-business transaction

(76) Inventors: Siu Lung Cheng, Hong Kong (CN); Ha Yin Wong, Hong Kong (CN); Kam Hing Lau, Hong Kong (CN)

Correspondence Address: KNOBBE MARTENS OLSON & BEAR LLP, 2040 MAIN STREET, FOURTEENTH FLOOR, IRVINE, CA, 92614, US

(21) Appl. No.: 11/334,995

(22) Filed: Jan. 18, 2006

(51) Int. Cl. G06Q 99/00

(52) U.S. Cl. 705/65

(57) ABSTRACT

A system and method of conducting secure business-to-business transactions by exchanging commitments and secure transaction tokens, where two levels of verification stringency are used for increasing the efficiency while maintaining sufficient security. The commitments are verified by a more stringent standard, such as PKI operations while the secure transaction tokens are verified by a more efficient but less stringent standard such as hash operations. The transaction token both represents a monetary value and provides an instruction on how to treat the monetary value it represents. In other words, the token has dual attributes: value and type. Particular embodiments based on the well-known PayWord specification are disclosed.

### FIELD OF THE INVENTION

The present invention relates to secure business transactions by electronic means. In particular, it relates to a method and system for secure transactions among two or more business entities by efficiently and securely maintaining a digital record of transactions, which maintains sufficient data integrity and subjects the transaction to no repudiation.

### BACKGROUND OF THE INVENTION

Public key cryptography has been used to provide encryption and digital signatures. In a public key infrastructure (PKI), a user has a key pair of private key and public key, where the private key is kept secret to the user and the public key is known to the public. The PKI protocol has many applications. One important application is for digital signatures. The user can sign a signature on a message using her private key so that other people can use her public key to verify the validity of the signature. The signature can be used for user authentication, data integrity and non-repudiation purposes. But the existing PKI system is facing a serious challenge due to its heavy demand for computational power.

Payword or PayWord, a scheme not as stringently secure as the PKI method, is nonetheless suitable as an e-cash scheme for micropayment (frequent payments involving small amounts). With Payword, users can pay the vendors directly in offline mode. The main advantage of using Payword for micropayment is that it is much more efficient than the normal PKI approach. It uses hash operations instead of public key operations whenever possible. Hash operations are about 100 times faster than PKI signature verifications and 10000 times faster than PKI signature generations.

In Payword, the user needs to establish an account with a bank. The bank will issue a digitally-signed Payword Certificate containing the user's public key and other related particulars. Before first payment, a payword chain ω₁, ω₂, . . . ωₙ is created in reverse order by selecting the last payword ωₙ randomly with a predefined length of bytes and computes
ωᵢ=h(ωᵢ+1)
for i=n−1, n−2, . . . , 0. Here, h(•) is a cryptographically strong hash function and ω₀ is the root of the payword chain, which is not a payword itself. The ω₀ and the user information is packaged and signed as a “commitment”, which is sent to the vendor in the first payment. In a particular application, each payword ωᵢ represents an amount, say one cent. Assume that the user has paid x cents to the vendor before, in order to pay for another y cents, the user sends a pair P=(ω_{x+y}, x+y) to the vendor. The vendor can verify the validity of the payword chain by check the hash in reverse order up to ω₀.

In business-to-business transaction, there are normally more than two parties involved in a single transaction. For example, a simple end to end transaction may include merchant, product provider and billing agent. All parties are connected through a central broker who controls the entire transaction process. FIG. 1 shows an exemplary transaction message flow among different parties.

Since each party may share a portion of transaction profits, a secure transaction scheme and system is needed to secure and maintain authenticity and integrity of each transaction message to avoid any repudiation. The PKI can achieve this purpose but it demands a great computational power. Imagine that PKI signature and verification process is needed between every two parties in every transaction, a simple end-to-end transaction may need a long time to finish. It would become a bottleneck when a large number of transactions are waiting to be processed. A new protocol that reduces the computational burden to a reasonable level is needed to address this issue.

### SUMMARY OF THE INVENTION

As one embodiment, there is provided a method for conducting secure transactions among business partners, including the acts of

(i) transmitting from a first computer device to a second computer device a certificate (it is unnecessary that the certificate is stored in said first computer before being sent to said second computer);

(ii) transmitting from said first computer device to said second computer device a commitment;

(iii) verifying said commitment using said certificate by said second computer device;

(iv) transmitting from said first computer device to said second computer device a secure transaction token having both a monetary attribute and a type attribute; and

(v) verifying said secure transaction token using information in said commitment, wherein said first computer device belongs to one business partner and said second computer device belongs to another business partner and said acts are carried out in the order of from (i) to (v) or in another suitable order. Preferably, the commitment is verified by PKI operations using the certificate while the secure transaction token is verified by a less stringent but more efficient method, such as, for example, hash operations. Examples of the type attribute for secure transaction tokens are “request,” “grant,” “reject,” etc.

As another embodiment, there is provided a system of keeping record of business transactions among two or more business partners, comprising a plurality of interconnected computing devices each of which belongs to one of said business partners where (a) said computer device is adapted to generate secure transaction tokens each of which comprises an indication of said token's monetary value and an indication of said token's type and (b) each transaction is recorded by a process comprising a business partner's sending one or more secure transaction tokens and another business partner's receiving and storing of said one or more secure transaction tokens. Preferably, computer devices are a computer running a server system or personal computer running an operating system which is Windows, Linux, Unix or Mac OS. In certain embodiments, the computer devices are contemplated to include an electronic device that has a processor, storage and network capability but has no operating system. Preferably, a software or hardware module is installed to enable the computer system to generate its own commitments and secure transaction tokens, and to verify and store commitments and secure transaction tokens received from other computer devices.

The various features of novelty which characterize embodiments of the invention are pointed out with particularity in the claims annexed to and forming a part of this disclosure. For a better understanding of the embodiments, its operating advantages, and specific objects attained by its use, reference should be made to the drawings and the following description in which there are illustrated and described preferred embodiments of the invention.

### BRIEF DESCRIPTION OF DRAWINGS

FIG. 1 is a diagram that depicts a typical situation involving business transactions among multiple business entities for which the present method and system is suitable.

FIG. 2 is a diagram that shows the main steps involved in conducting secure transaction.

FIG. 3 is a diagram that shows the flow of transaction messages using the present system and method involving the same business entities as in FIG. 1.

FIG. 4 is a screen display that exemplifies a user interface for administrating a broker's secure transaction system.

### DETAILED DESCRIPTION OF PARTICULAR EMBODIMENTS

Setup Process

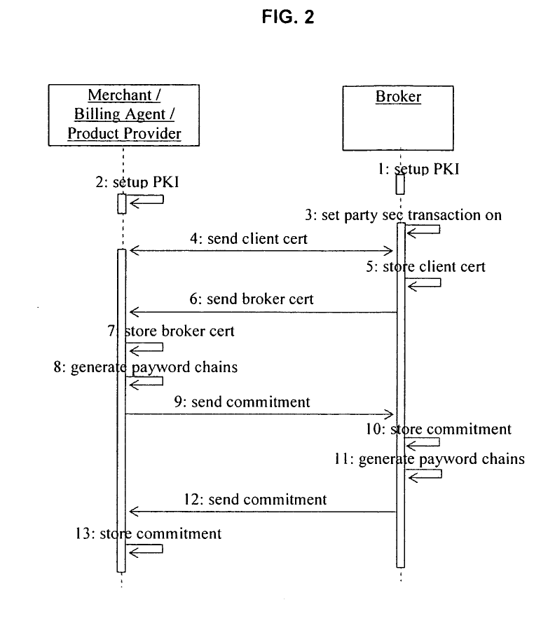

In a particular embodiment, the system involves a broker and a number of business partners, including a merchant, a product provider and a billing agent. Of course, this is by example only, more or fewer parties could participate in the system. Before starting any transactions, a setup process is conducted between the transaction parties. In the setup, the parties exchange the payword commitment with each other. FIG. 2 shows the message flow in the setup process which is detailed in the following.

(1) Broker is loaded with his public and private key pair which is certified by a public CA (Certificate Authority).

(2) Merchant/product provider/billing agent are each loaded with its public and private key pair, which is certified by a public CA. Alternatively, the broker can also act as a CA to sign the key pair for its partners.

(3) To set up the merchant/product provider/billing agent system to support secure transaction scheme, the broker operator turns on the secure transaction option for the particular party in its profile. The broker should have reached an agreement with the particular party in advance regarding the use of the secure payment method.

(4) The merchant/product provider/billing agent each sends its certificate to the broker.

(5) The broker stores the partner's certificate in the broker system.

(6) The broker sends its own certificate to the partner whose certificate has been stored in the broker.

(7) The merchant/product provider/billing agent each stores the broker's certificate into its own system.

(8) The merchant/product provider/billing agent each generates its Payword chains. There are various types of Payword chains, such as, request chains, grant chains, reject chains, confirmation chain, etc. Each Payword chain contains a predetermined number of Payword units. The party who sends out the request transaction is referred to as a Requester. The party who responds to a request transaction message is referred to as a Responder. The Requester generates and uses request chains, and the Responder generates and uses grant and reject chains. In the example depicted in FIG. 2, the merchant is the Requester, while the billing agent and product provider are the Responder. In the setup between the merchant and the broker, the merchant generates the request Payword chains and the broker generates grant and reject Payword chains. A plurality of chains of a type may be generated in the setup process. Each Payword unit in the chain may represent a particular amount. For example, the merchant may generate 3 request Payword chains where each chain's Payword unit represents $0.1, $1 and $10, respectively. By packing a combination of the Payword units of different values into a transaction token, the token can represent any transaction amount.

(9) The merchant/product provider/billing agent each sends out the commitment of generated Payword chains. The commitment contains the following information which is signed with the generator's private key:

i. Information About All the Chains Generated and to be Committed

1. chain 1 (chain type, chain amount, chain root)

2. chain 2 (chain type, chain amount, chain root)

3. chain 3 (chain type, chain amount, chain root)

4. . . .

ii. Generator Information

Generator name, commitment generation time, commitment valid period, etc.

(10) The broker verifies the commitment signature and stores it in its local system persistently.

(11) Depending on the type of the commitment received, the broker generates suitable Payword chains. If the received commitment contains request chains, it will generate grant and reject chains. On the other hand, if the received commitment contains grant and reject chains, it will generate request chains.

(12) The broker packages the commitment, which contains general information and information about the Payword chains to be committed, and sends it to the corresponding partner.

(13) The corresponding merchant/product provider/billing agent each verifies the signature of commitment and stores it in its local system persistently. The commitment is verified by a stringent PKI scheme.

Secure Transaction

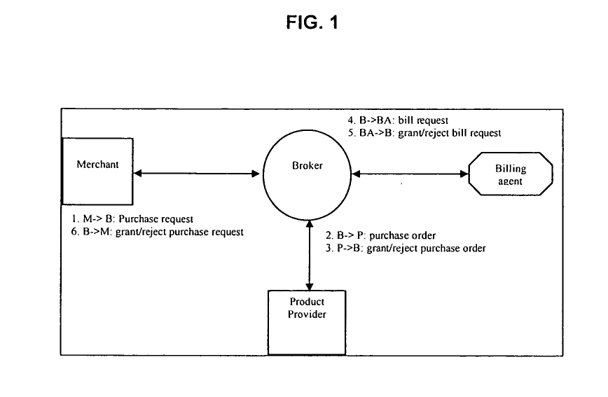

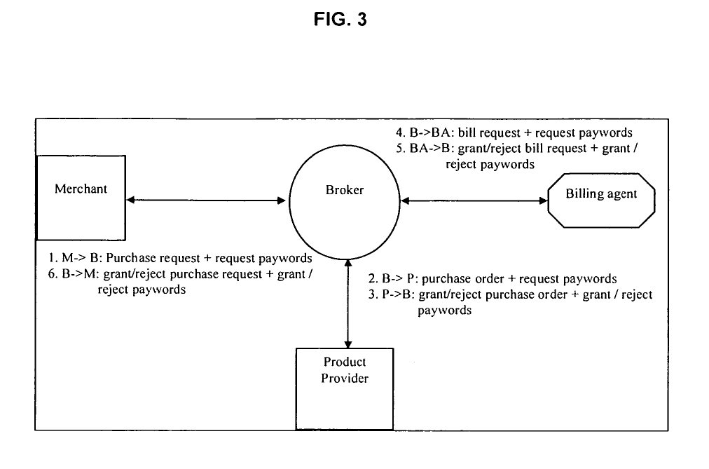

After the setup, the broker and the parties can begin transactions in a way that is secure and subject to no repudiation. The transaction message flow is shown in FIG. 3, which is basically the same as in FIG. 1 except that a transaction token is added to each transaction message.

(1) In order to initiate a purchase request involving a value of $x using the secure transaction scheme, the merchant sends out a transaction token containing one or more Payword units from request chains, representing a value of $x. For example, the merchant's system has 3 request chains: a $0.1 chain where each unit represents $0.1; a $1.0 chain where each unit represents $1.0; a $10.0 chain where each unit represents $10.0. To request for a new purchase worth $23.5, the merchant will send to the broker a purchase order attached with a request transaction token containing a combination Payword unit at index a+5 of $0.1 request chain, a Payword unit at index b+3 of $1.0 request chain, and a Payword unit at index c+2 of $10.0 request chain, that is, (a+5 of $0.1)+(b+3 of $1.0)+(c+2 of $10.0), where “a,” “b,” and “c” are the index of the Payword unit that was last used in each chain, respectively.

(2) Upon receiving the purchase order, the broker verifies the request token (that is, the combination of Payword units from the request chains whose information is known to the broker from the commitment already provided by the merchant) and, if there is no problem with the request token, sends the purchase order attached with a request transaction token containing its own request Payword units of a proper total value (with or without a markup or markdown) to the product provider. On the other hand, if the request token fails the verification process, a reject token of a proper value will be sent back to the merchant to end the transaction.

(3) The product provider processes the purchase order and verifies the request token from broker. If the token passes the verification process and the product provider accepts the purchase order, meaning that the purchase order is successful, the product provider sends the broker a grant token of a proper value (typically, equal to the value of the request token received from the broker but can be different). If for whatever the reason the purchase order fails, the product provider sends a reject token of a proper value back to the broker. In turn, the broker sends a reject token of a proper value back to the merchant to ends the transaction.

(4) In case the broker receives a grant token from the product provider, it then sends to the billing agent a bill request attached with its own request token of a proper value.

(5) The billing agent processes the bill request and verifies the request token. If everything is in order, it sends its own grant token of a proper value to the broker. Otherwise, a reject token of a proper value will be sent to the broker.

(6) If the broker receives a reject token from the billing agent, it will send its own reject token of a proper value back to the merchant and ends the transaction, meaning that it is a failed transaction. On the other hand, if the broker receives a grant token from the billing agent, meaning the entire transaction is successful, it then sends its own grant token of a proper value to the merchant. Meanwhile, the broker also sends a confirmation token of a proper value to the product provider to confirm the transaction.

(7) Only upon receiving the confirmation token from the broker, should the product provider have the purchased goods delivered to the purchaser to complete the entire transaction. As an alternative to the above process, after broker received the request token from the merchant, the broker sends out an order to the product provider. The order doesn't contain any payword token. When the product provider receives the order, it checks its inventory, reserves the product and sends back a Payword request token. After the broker finishes the billing process, the broker will send back a Payword grant token to the product provider and the product will be delivered. If there is any error, a reject token will be sent to the product provider and the merchant and the product provider can release the reserved product.

The transaction tokens used between any two parties are independent, e.g., during the same transaction the request token sent from the broker to the product provider is different from the request token sent from the broker to the billing agent. The token is made up of Payword units from the proper Payword chains generated and committed by the sender, rather than by forwarding the token generated and sent by another party. The value of the tokens sent to the product provider and to the billing agent may be the same or different depending whether there is any markups or markdowns relative to a particular business party or some other reasons. As the broker deals with a number of parties in this example, it needs to prepare different Payword chains for each party. Payword chains may be generated during the setup and also afterward when tokens are used out. Commitment, payword chains and transaction tokens

The commitment is sent out when the system is doing the setup process or new Payword chains are generated and ready to commit. A commitment is like a general or master notice from the sending party to the receiving party in which the sending party informs the receiving party that any transaction tokens received by the receiving party that satisfy the conditions specified in this commitment will honored by the sending party. As an example only, Table 1 illustrates the contents that a commitment may include.

TABLE 1
Content of an Exemplary Commitment

| Element | Description |
|---|---|
| Maker | It is a reference to the party that generate the |
| | commitment |
| Chain Information | A chain Information may contain a list of |
| | following data: {Chain ID, Chain Value, Chain |
| | Type, Root Payword}. The Chain ID is a unique |
| | ID of the chain for every party. The Chain value |
| | is the value that each payword represents, for |
| | example, $0.2. The Chain Type is a reference to |
| | the instruction on how to treat the associated |
| | chain value. Four exemplary types/instructions |
| | are request, grant, reject and confirmation. |
| | Other types are possible. Root Payword is the |
| | first payword in the payword chain. |
| Generate Date | Chain may have an expiration period, say 1 month, |
| | which may be measured from the Generate Date. |
| | The length of period depends on the chain length, |
| | the transaction frequency and these curity level |
| | that the system requires. |
| Signature | A signature from the maker. The signature should |
| | be verifiable by the public key in the maker's |
| | certificate. |

In contrast to the subsequently transmitted Payword units contained in a transaction token pursuant to the commitment, which use a hash operation for verification, the commitment itself uses a more stringent PKI verification scheme. This represents a balanced approach between efficiency and security, a feature extended from the Payword technique.

A commitment may contain information for more than one chain. For example, a commitment exchanged during a setup process contains information about 6 chains: a grant chain with chain value $0.1, a grant chain with chain value $1, a grant chain with chain value $10, a reject chain with chain value $0.1, a reject chain with chain value $1 and a reject chain with chain value $10. After one or more chains are used up, one or more new chains may be generated and a commitment will be transmitted to cover the new chains so that the receiving party will be able to accept the token of the new chains. Without first sending the new commitment, the tokens of the new chains would be rejected by the receiving party.

Table 2 shows an exemplary content of a transaction token according to certain embodiments. As shown, the token contains three elements: Type, Value, and ID. Token type specifies the instruction on how to treat the associated token value. Examples are: Request, Grant, Reject, Confirmation, etc. Therefore, unlike conventional use of Payword tokens, which are treated or used like currency in exchange for goods or services, the transaction token (as well as the Payword units contained therein) of the present system and method contains an additional piece of information so the token/Payword units not only symbolizes an amount of money involved but also symbolizes what type of the money it is, e.g., it represents a rejected amount of money, granted amount of money or requested amount of money, etc. As shown in Table 2, the transaction token may contain one or more units from different Payword chains combined to represent a particular value.

TABLE 2
Content of a Transaction Token

| Element | Description |
|---|---|
| Token Type | Request, Grant, Reject, etc. |
| Token Value | The amount of the token represents. |
| Payword Values | Payword values may contain a list of Payword units |
| | with the following data: {Chain ID, Payword unit, |
| | increased Index}. The Chain ID is the unique ID of |
| | the chain. The system can use this ID to find the |
| | corresponding chain information. The Payword unit is |
| | the token that represents a corresponding amount and |
| | has a type attribute. Increased Index is the index |
| | difference from the current payword to the last |
| | received payword in the record. |

To be acceptable to a receiving party, all the Payword units in a transaction token must be within the scope of a commitment previously received and verified by the receiving party. Although, the commitment is verified by a more stringent scheme such as the PKI method, subsequently transmitted Payword units in a transaction token should use a less stringent but more efficient scheme, such as a hash operation as exemplified herewith.

When a business party receives a token, it can use the chain ID to find the chain value, chain type, and find the last received Payword unit in the same chain from the corresponding commitment. The Payword unit in the token can be verified by the hash current Payword token and increased index times to see if it is equal to the last received Payword unit. The total amount can be verified by the sum of the increased amount in each chain. Then the current Payword unit is recorded down for the next Payword unit's verification. The process is illustrated by the following example.

Example: one receiving party/system receives a transaction token, containing the following information: token type: request; total amount $12.5; Payword value {Chain ID 1, Payword 6243095e84b0a7490d3a68671e7a02d2beb2dc29, Increased Index 5}, Payword value {Chain ID 2, Payword ce9408a3715b0590f98b0bd8becc5e232c155fbb, Increased Index 2}, Payword value {Chain ID 3, Payword da39a3ee5e6b4b0d3255bfef95601890afd80709, Increased Index 1}. From the system record (based on the information conveyed by a previously received and verified commitment), it is known that Chain 1 is a request chain with chain value $0.1, the last received payword is 86f7e437faa5a7fce15d1ddcb9eaeaea377667b8. Chain 2 is a request chain with chain value $1, the last received payword is a9993e364706816aba3e25717850c26c9cd0d89d. Chain 3 is a request chain with chain value $10, the last received payword is 7b3d754b87bcf5d364633af3321f7fa884ac2428. The receiving system hashes the Payword 6243095e84b0a7490d3a68671e7a02d2beb2dc29 5 times to see if it is equal to 86f7e437faa5a7fce15d1ddcb9eaeaea377667b8. If yes, the payword 6243095e84b0a7490d3a68671e7a02d2beb2dc29 in chain 1 is valid. Then, by the same method, the receiving system verifies the other paywords of different chains. Finally, the receiving system can calculate the total value to see if it is equal to the token amount, i.e., $0.1*5+$1*2+$10*1 in this example.

Although the above description is specific to the embodiments based on the Payword scheme, other similar secure schemes may also be suitable for practicing the present invention. It is contemplated that any secure scheme that uses a chain of token that can contain information not only about the “value” it represents but also about the “type” it represents, will be suitable and come within the scope of the embodiments of the present invention.

Implementation of Secure Transaction System

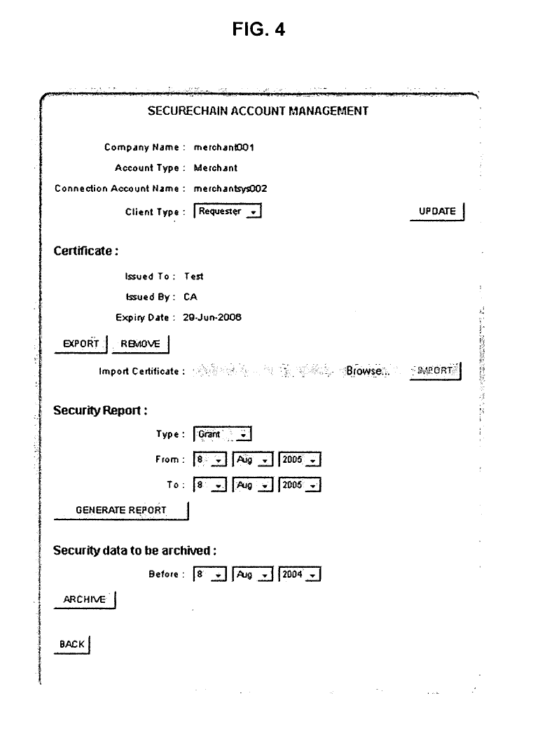

As a particular embodiment, the secure transaction system can be divided into 2 subsystems: client and server, which typically are software implementations. The server is installed into the broker machine to process the setup request from other parties and provide component to generate and verify necessary payword chains of transaction tokens. The client is installed into each partner machine, which is responsible for initiating the setup request and for generating its own token chains and verifying transaction tokens received from the broker. Both subsystems include a user interface for administration tasks, such as generating transaction report, configuring the security setting, etc. FIG. 4 is an example showing a web interface provided by the secure transaction server system. The following is with reference to FIG. 4, describing a particular implementation of the administrator interface.

“Account Type” specifies the business partner's type, such as merchant, product provider and billing agent, etc.

“Connection Account Name” is the identification of a partner's connection account, as a business partner may have several connection accounts and thus may have more than one computer connected to the broker server at the same time.

“Client Type” means the client type of a connection account. There are 2 types of clients: Requester and Responder. The Requester only sends out Request transaction tokens while the Responder only sends out Grant and Reject transaction tokens. The client type setup can help the system to improve performance since the system doesn't need to prepare any token chain that the client will never use.

“Certificate” is the certificate of the business partner. The business partner should send the certificate to the broker operator before beginning any security transaction. The operator imports the partner's certificate to the server security system. The system will verify the certificate automatically and save it to the database. The system also provides the interface for operator to update and remove the certificate.

“Security Report” allows the operator to generate a transaction report in a specified interval. The report includes all transaction tokens that exchanged during the interval. It can help the operator to do payment settlement with the partners.

“Archive Security Data” allows the operator to archive the secure transaction data (tokens) at a predetermined cutoff date. Once the data is archived, it can no longer be used to generate the security report.

A prototype of a secure transaction system according to one embodiment of the present invention was built where a merchant simulator system, billing agent simulator system, product provider simulator system and broker simulator system were constructed to use the secure transaction method. The simulator systems were running in a single machine and sent the transaction message to each other by using TCP/IP connections. All transaction data were saved in a local file system.

Table 3 shows the testing results using different Payword chain value combinations. All chain lengths are 1000, the transaction amount range is from 0 to 100 and the rejection rate is 1%. The setup time is the total setup time of merchant, broker and billing agent. The process time is the time of an end to end transaction that involves all the business partners and the broker.

TABLE 3
Test Results with Chains of different values

| | Process Time | Setup Time |
|---|---|---|
| Chain Value | (ms/transaction) | (ms) |
| {0.1, 0.2, 0.5, 1, 2, 5, 10, 20, 50, 100} | 1 | 1140 |
| {0.1, 0.2, 0.5, 1, 2, 5, 10, 20, 50} | 1 | 1047 |
| {0.1, 0.2, 1, 2, 10, 20} | 1.2 | 688 |
| {0.1, 0.5, 5, 50} | 1.6 | 453 |
| {0.1, 1, 10, 50} | 1.6 | 469 |
| {0.1, 1, 10} | 1.8 | 359 |
| {0.1, 1, 2, 5} | 1.9 | 469 |
| {0.1, 1, 5} | 2 | 344 |
| {0.1, 5, 20} | 3.2 | 344 |
| {0.1, 5, 50} | 3.4 | 344 |
| {0.1, 5, 10} | 3.4 | 359 |
| {0.1, 5} | 4 | 234 |
| {0.1, 1} | 6 | 234 |
| {0.1, 10} | 6 | 234 |
| {0.1, 0.2, 0.5} | 11 | 344 |
| {0.1, 20} | 11.2 | 235 |
| {0.1, 50} | 29.6 | 218 |
| {0.1} | 65.4 | 109 |

Table 4 is the testing result using payword chain values {0.1, 1, 10} with different chain lengths. The transaction amount range is from 0 to 100 and the rejection rate is 1%. In one embodiment, the memory required for paywords storage is calculated by the following formula: chain length*payword size*chains number, where payword size is 20 bytes, chains number in broker is 3. The required memory size may vary in different OS and programming languages. For example, in our prototype (Windows 2000, Java 1.4), a 1000 length payword chain allocates 42k memory, where the commitment is 4k, 1000 paywords is 36k, and other data is 2k.

TABLE 4
Test Results with Chains of different Length

| | Process Time | Memory Required in broker system |
|---|---|---|
| Chain Length | (ms/transaction) | (Kbytes) |
| 10000 | 0.7 | 600 |
| 5000 | 0.9 | 300 |
| 2500 | 1.1 | 150 |
| 2000 | 1.2 | 120 |
| 1500 | 1.4 | 90 |
| 1000 | 1.8 | 60 |
| 750 | 2.1 | 45 |
| 500 | 2.9 | 30 |
| 250 | 5.2 | 15 |
| 100 | 12.2 | 6 |
| 50 | 24.7 | 3 |

Table 5 is the testing result using a special transaction value set {78, 80, 88, 98} with fixed transaction amount randomly chose from {78, 80, 88, 98}.

TABLE 5
Test Results with a Special Transaction Values Set

| | Process Time | Memory Required in broker server |
|---|---|---|
| Chain Length | (ms/transaction) | (Kbytes) |
| 50 | 2.1 | 3 |
| 100 | 1.2 | 6 |
| 200 | 0.8 | 12 |
| 300 | 0.7 | 18 |
| 400 | 0.6 | 24 |
| 500 | 0.6 | 30 |
| 1000 | 0.5 | 60 |
| 1500 | 0.4 | 90 |
| 2000 | 0.4 | 120 |
| 5000 | 0.4 | 300 |
| 10000 | 0.4 | 600 |

As a comparison, when Payword was replaced with PKI, the process time for an end transaction is 70 ms with the transaction amount range from 0 to 100 and the rejection rate as 1%.

As used in this disclosure, “secure transaction token” means a digital file whose integrity and authenticity can be verified. In the present system and method, the secure transaction token used has both monetary and category attributes. The category attribute or “type” specifies how to categorize or dispose the amount of money symbolized by the token, such as, in an accounting process. For example, if a secure transaction token has a monetary value of $10 and is of a “reject” type, the token would represent a rejected item worth $10. Other examples of the type attribute is “grant,” “confirm,” “recant,” “request,” “inquiry,” etc. New type attributes can always be created to suit particular situations.

While there have been described and pointed out fundamental novel features of certain embodiments, it will be understood that various omissions and substitutions and changes, in the form and details of the embodiments illustrated, may be made by those skilled in the art without departing from the spirit of the invention. The invention is not limited by the embodiments described above which are presented as examples only but can be modified in various ways within the scope of protection defined by the appended patent claims.

What is claimed is:

1. A system of keeping record of business transactions among two or more business partners, comprising a plurality of interconnected computing devices each of which belongs to one of said business partners where (a) said computer device is adapted to generate secure transaction tokens each of which comprises an indication of said token's monetary value and an indication of said token's type and (b) each transaction is recorded by a process comprising a business partner's sending one or more secure transaction tokens and another business partner's receiving and storing of said one or more secure transaction tokens.

2. The system of claim 1, wherein one or more components of said one or more secure transaction tokens are generated and verified according to the Payword specification.

3. The system of claim 2, wherein said computer devices are interconnected through the Internet.

4. The system of claim 3, wherein a plurality of Payword chains are generated in one or more of said computer devices; each of said Payword chains comprising a root unit and a plurality of Payword units; each of said Payword units having a monetary attribute and a type attribute.

5. The system of claim 4, wherein at least one of said Payword chains comprises Payword units of a request type.

6. The system of claim 5, wherein at least one of said Payword chains comprises Payword units of a grant type or a reject type.

7. The system of claim 4, wherein said one or more secure transaction tokens comprises one or more Payword units from one or more said Payword chains.

8. The system of claim 7, wherein said business partners comprise one broker, one or more product providers, one or more billing agents, and one or more merchants.

9. The system of claim 8, wherein each of said computer devices is adapted to store one or more transaction tokens received from another computer device and to generate a transaction report at a predetermined interval accounting for secure transaction tokens received and stored in each of said computer devices.

10. The system of claim 9, wherein said computer devices are a computer running a server system or personal computer running an operating system which is Windows, Linux, Unix or Mac OS or any device having a computing processor and storage capability.

11. A method for conducting secure transactions among business partners, comprising:
(i) transmitting a certificate from a first computer device to a second computer device;
(ii) transmitting a commitment from said first computer device to said second computer device;
(iii) verifying said commitment using said certificate by said second computer device;
(iv) transmitting from said first computer device to said second computer device a secure transaction token having both a monetary attribute and a type attribute; and
(v) verifying said secure transaction token using information in said commitment; wherein said first computer device belongs to one business partner and said second computer device belongs to another business partner and said acts are carried out in the order of from (i) to (v) or in another order.

12. The method of claim 11, wherein said secure transaction token is verified in act (v) by a first verification standard and said commitment is verified by a second verification standard, and wherein said first verification standard is less stringent but more efficient than said second verification standard.

13. The method of claim 12, wherein said first verification standard is based on a hash operation and said second verification standard is based on a public key infrastructure (PKI) authentication.

14. The method of claim 13, wherein said secure transaction token comprises at least one Payword unit of a predetermined value and a predetermined type taken from a Payword chain whose information is provided in said commitment.

15. The method of claim 14, wherein said secure transaction is between business entities.
